(19) United States
(12) Patent Application Publication
(10) Pub. No.: US 2021/0055927 A1
(43) Pub. Date: Feb. 25, 2021

(54) SYSTEMS, METHOD, AND MEDIA FOR DETERMINING SECURITY COMPLIANCE OF CONTINUOUS BUILD SOFTWARE

(71) Applicant: Skyhigh Networks, LLC, Campbell, CA (US)

(72) Inventors: Sekhar Sarukkai, Cupertino, CA (US); Prasad Somasamudram, Bangalore (IN)

(21) Appl. No.: 16/549,350

(22) Filed: Aug. 23, 2019

(51) Int. Cl. G06F 8/71; G06F 8/65; G06F 21/54; G06F 11/36

(52) U.S. Cl. CPC G06F 8/71; G06F 8/65; G06F 11/3692; G06F 11/3688; G06F 21/54

(57) ABSTRACT

Mechanisms for determining security compliance of continuous build software are provided. In some embodiments, the mechanisms comprise: receiving a trigger at a hardware processor from a continuous build tool indicating that code has been created or updated; receiving a code template corresponding to the code at the hardware processor; checking the code template against a plurality of policies to determine if there is a security violation; and indicating that the code template has passed a compliance check prior to a code stack for the template being built by the continuous build tool.

### BACKGROUND

Cloud computing has had a positive impact on businesses, and vendors like AMAZON WEB SERVICES (“AWS”), MICROSOFT AZURE, and GOOGLE CLOUD PLATFORM have been very successful with large numbers of customers. However, the process for deploying cloud computing infrastructure is complicated and error prone. Also, many customers lack the skills and experience necessary to setup the infrastructure successfully.

With the introduction of various tools from service providers, customers can now orchestrate and deploy cloud computing infrastructure and applications on cloud platforms in a structured format and with granular levels of control. However, customers having the ability to orchestrate and deploy cloud computing infrastructure and applications on cloud platforms introduces the possibility of risk in terms of compliance and security exposure from a infrastructure perspective.

Securing infrastructure defined as software has traditionally been post deployment by way of audit of configuration of the infrastructure. There are various tools that are available in the market today which can be used to conduct an audit of the configuration of deployed infrastructure. For example, some of these tools perform a periodic scan of the configuration of an infrastructure and report on compliance in terms of standards such as Center for Internet Security (CIS) benchmarks, Health Insurance Portability and Accountability Act of 1996 (HIPAA), Payment Card Industry Data Security Standard (PCI-DSS), National Institute of Standards and Technology (NIST), and more. These tools do not address the need of continuous development and deployment of applications in the cloud, however. Also, these tools require software to be deployed in order to audit the configuration of the infrastructure.

Accordingly, new mechanism for determining security compliance of continuous build software are desirable.

### SUMMARY

In accordance with some embodiments, systems, methods, and media for determining security compliance of continuous build software are provided. In some embodiments, systems for determining security compliance of continuous build software are provided, the systems comprising: a memory; and a hardware processor coupled to the memory and configured to: receive a trigger from a continuous build tool indicating that code has been created or updated; receive a code template corresponding to the code; check the code template against a plurality of policies to determine if there is a security violation; and indicate that the code template has passed a compliance check prior to a code stack for the template being built by the continuous build tool.

In some embodiments, methods for determining security compliance of continuous build software are provided, the methods comprising: receiving a trigger at a hardware processor from a continuous build tool indicating that code has been created or updated; receiving a code template corresponding to the code at the hardware processor; checking the code template against a plurality of policies to determine if there is a security violation; and indicating that the code template has passed a compliance check prior to a code stack for the template being built by the continuous build tool.

In some embodiments, non-transitory computer-readable media containing computer-executable instructions that, when executed by a processor, cause the processor to perform a method for determining security compliance of continuous build software are provided, the method comprising: receiving a trigger at a hardware processor from a continuous build tool indicating that code has been created or updated; receiving a code template corresponding to the code at the hardware processor; checking the code template against a plurality of policies to determine if there is a security violation; and indicating that the code template has passed a compliance check prior to a code stack for the template being built by the continuous build tool.

### BRIEF DESCRIPTION OF THE DRAWINGS

FIG. 1 is an example of a flow diagram illustrating a mechanism for determining security compliance of continuous build software in accordance with some embodiments.

FIG. 2 is an example of a process for a serverless application in accordance with some embodiments.

FIG. 3 is an example of a process for a continuous build tool in accordance with some embodiments.

FIG. 4 is an example of a process for performing a compliance check in accordance with some embodiments.

FIG. 5 is an example of a code template in accordance with some embodiments.

FIG. 6 is an example of hardware components that can be used in accordance with some embodiments.

FIG. 7 is an example of hardware that can be used to implement some of the components of FIG. 6 in accordance with some embodiments.

### DETAILED DESCRIPTION

In accordance with some embodiments, mechanisms (which can include systems, methods, and media) for determining security compliance of continuous build software are provided.

For example, in some embodiments, these mechanisms can implement an infrastructure as code (IaC) assessment system that analyzes IaC code for compliance with one or more policies to ensure compliance and security of a corresponding infrastructure on one or more cloud platforms.

In some embodiments, the mechanisms described herein can review a code template to determine if a code stack to be implemented based on the code template will comply with security policies. In some embodiments, a code template can include instructions on how to spin up cloud infrastructure and can be stored as a JAVASCRIPT OBJECT NOTATION (JSON) or a YAML file type. In some embodiments, the code template can be in a declarative format that describes cloud resources that need to be provisioned in a cloud infrastructure provider. In some embodiments, the code templates can be files which are stored in a network storage or a version control system.

In some embodiments, the mechanisms described herein provide security checks that enable application developers and owners to get early visibility and control of potential security issues well before their infrastructure is spun up in a cloud environment, while providing the ability for central security teams to define consistent infrastructure security policies.

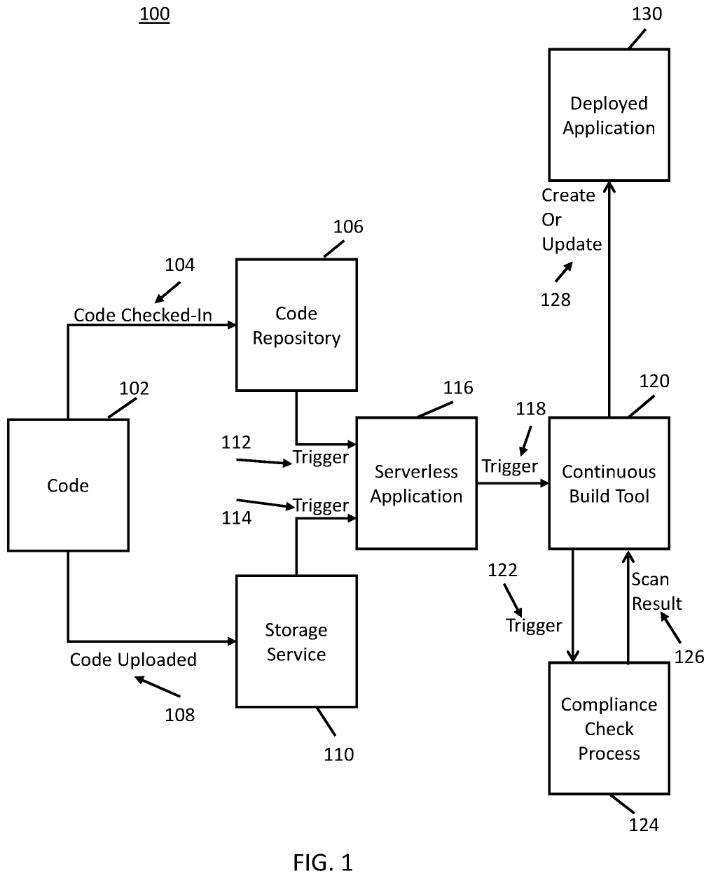

Turning to FIG. 1, an example 100 of a flow diagram illustrating a mechanism for determining security compliance of continuous build software in accordance with some embodiments is shown. As illustrated, code 102 is created, updated, or deleted by a user. This code is then checked-in to a code repository 106 at 104 or uploaded to a storage service 110 at 108. This check-in or upload triggers a serverless application 116 at 112 or 114, respectively. The serverless application in turn triggers a continuous build tool 120 at 118. The continuous build tool then causes a compliance check process 124 to be triggered at 122. In response, the compliance check process provides a scan result 126 to the continuous build tool. If the scan result indicates that the compliance check has passed, then a deployed application 130 is created or updated at 128 by the continuous build tool. Otherwise, the continuous build tool will terminate the build process.

Code 102 can be any suitable code in some embodiments. For example, in some embodiments code 102 can be code for an infrastructure as code (IaC), a software as a service (SaaS), a platform as a service (PaaS), and/or any other suitable code.

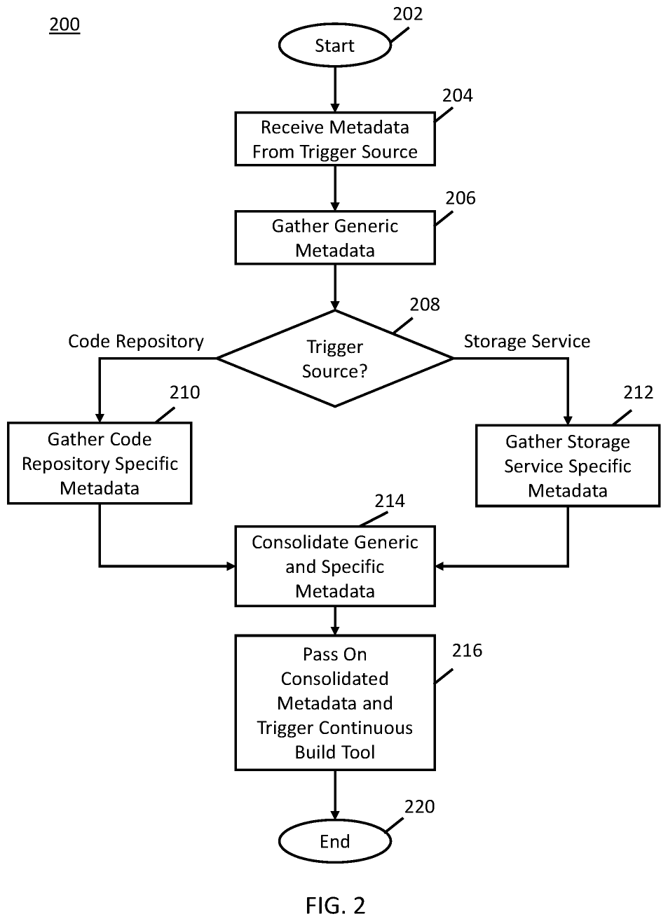

FIG. 2 illustrates an example 200 of a process for serverless application 116 of FIG. 1 in accordance with some embodiments. This process can be part of a larger process in some embodiments.

In some embodiments, process 200 can be started at 202 in response to a trigger at 112 or 114 of FIG. 1.

After process 200 begins, the process can receive metadata from the trigger source (i.e., code repository 106 or storage service 110) at 204. The metadata can be received in any suitable manner and can include any suitable information. For example, in some embodiments, the metadata can be received as a JSON Object. As another example, in some embodiments, the metadata can include user details (e.g., username and/or email address) of the user who caused the trigger, a trigger name, an identifier of the source of the trigger (i.e., code repository 106 or storage service 110), changes that occurred in source of the trigger (e.g., a file was created, updated, or deleted), a change identifier (ID), a parent change ID, a path to the file that caused the trigger, a message that was provided by the user, and/or any other suitable information.

Next, at 206, process 200 can gather generic metadata. This metadata can include any suitable information, and the metadata can be gathered in any suitable manner. For example, in some embodiments, the metadata can include a stack name, other file names if multiple files are checked in as part of a single check in, a stack create/update/delete, etc. As another example, in some embodiments, the metadata can be gathered by a serverless applications.

Then, at 208, process 200 can determine whether the trigger source was code repository 106 or storage service 110. This determination can be made in any suitable manner. For example, this determination can be made based on data (such as an IP address) in a trigger message received by the serverless application at 112 or 114 of FIG. 1.

If process 200 determines at 208 that the trigger source was the code repository, then process 200 can branch to 210 and gather code repository specific metadata. This metadata can include any suitable information, and the metadata can be gathered in any suitable manner. For example, in some embodiments, the metadata can include a stack name, other file names if multiple files are checked in as part of a single check in, a stack create/update/delete, etc. As another example, in some embodiments, the metadata can be gathered by a serverless applications.

Otherwise, if process 200 determines at 208 that the trigger source was the storage service, then process 200 can branch to 210 and gather storage service specific metadata. This metadata can include any suitable information, and the metadata can be gathered in any suitable manner. For example, in some embodiments, the metadata can include the storage service name and the URL to access it. As another example, in some embodiments, the metadata can be gathered by a serverless application.

After performing 210 or 212, process 200 can consolidate the generic event metadata and the specific metadata at 214. Any suitable portions or all of the generic event metadata and the specific metadata can be consolidated and the metadata can be consolidated in any suitable manner. For example, in some embodiments, the metadata that is consolidated can include a user name, a stack name, file name(s), etc. As another example, in some embodiments, the metadata can be consolidated by a build process.

Finally, process 200 can pass on the consolidated metadata to continuous build tool 120 and trigger the continuous build tool at 216 and then end at 220. Process 200 can pass on any suitable metadata to the continuous build tool, and can pass on the metadata to the continuous build tool in any suitable manner. For example, in some embodiments, the metadata passed on to the continuous build tool can include a user name, a stack name, file name(s), etc. As another example, in some embodiments, the metadata can be passed on to the continuous build tool by a serverless application.

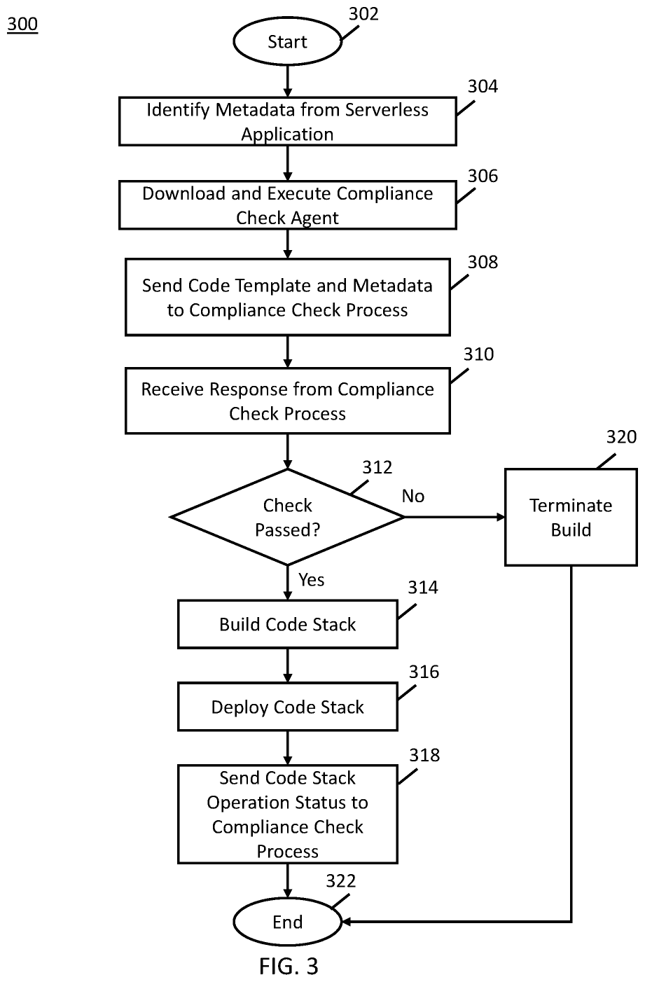

Turning to FIG. 3, an example 300 of a process for continuous build tool 120 in accordance with some embodiments is shown. This process can be part of a larger process in some embodiments.

In some embodiments, process 300 can be started at 302 in response to a trigger at 118 of FIG. 1.

As illustrated, after process 300 begins at 302, the process can identify metadata from the serverless application at 304. Any suitable metadata can be identified and the metadata can be identified in any suitable manner. For example, in some embodiments, the metadata can include a user name, a stack name, file name(s), etc. As another example, in some embodiments, the metadata can be identified by a build tool.

Next, at 306, process 300 can download and execute a compliance check agent. Any suitable agent can be downloaded, and the agent can be downloaded and executed in any suitable manner. For example, in some embodiments, the agent can be a process for passing data from the continuous build tool to a compliance check server. As another example, in some embodiments, the agent can be downloaded from a compliance check server.

Then, at 308, the compliance check agent can send the code template and metadata to a compliance check process. The code template can be any suitable template associated with the code created, updated, or deleted at 102 of FIG. 1 in some embodiments. For example, the code template can be a template describing an IaC configuration. The metadata can include any suitable information in some embodiments. For example, in some embodiments, the metadata can include a user name, a stack name, file name(s), etc. The code template and the metadata can be sent to the compliance check process by the compliance check agent in any suitable manner in some embodiments. For example, the code template and the metadata can be sent as a JSON file format.

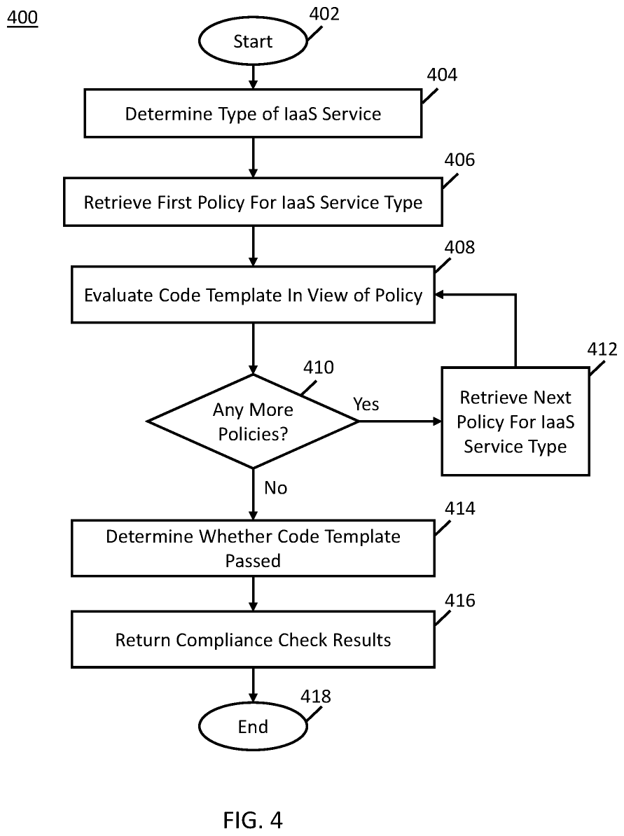

After the code template and the metadata are sent to the compliance check process, the compliance check process can determine whether the code described by the template complies with one or more rules. This determination can be made in any suitable manner in some embodiments. For example, this determination can be made as described below in connection with FIG. 4 in some embodiments.

At 310, process 300 can receive a response from the compliance check process. This response can include any suitable information and can be received in any suitable manner. For example, in some embodiments, this response can indicate that the compliance check has passed or failed. As another example, in some embodiments, this response can indicate details of a security violation in a code template such as the owner of the template, the date and the time when the template was put into the source of the trigger, the type of policy violations that were found, and what fix is needed for the security violation. As yet another example, in some embodiments, this response can be received as a JSON file.

Next, process 300 can determine whether the compliance check passed at 312. This determination can be made in any suitable manner in some embodiments. For example, in some embodiments, process 300 can determine that the compliance check passed based on an indicator in the response received at 310.

If it is determined at 312 that the compliance check passed, then process 300 can build a code stack corresponding to code 102 (FIG. 1) at 314, deploy the code stack at 316, and send a code stack operation status to the compliance check process at 318. The code stack can be built at 314 in any suitable manner in some embodiments. For example, in some embodiments, the code stack can be built by a build process. The code stack can be deployed at 316 in any suitable manner in some embodiments. For example, in some embodiments, the code stack can be deployed by a build process. The code stack operation status can include any suitable information and the status can be sent to the compliance check process in any suitable manner in some embodiments. For example, in some embodiments, the code stack operation status can indicate that the code stack is deployed and operational. As another, in some embodiments, the code stack operation status can be sent to the compliance check process as any suitable message from the compliance check agent to a compliance check server executing the compliance check process.

In some embodiments, in response to the code stack being built, the created/updated stack can be scanned to identify any policy violations that may have been introduced during the stack build operation and not detected during the initial scan due to unaccounted-for template behavior.

Otherwise, if it is determined at 312 that the compliance check did not pass, then process 300 can terminate the build at 320. Process 300 can terminate the build in any suitable manner in some embodiments.

After sending the code stack operation status at 318 or terminating the build at 320, process 300 can end at 322.

Turning to FIG. 4, an example 400 of a process for performing a compliance check in accordance with some embodiments is shown. This process can be part of a larger process in some embodiments.

Process 400 can be started at 402 in response to a trigger at 122 (FIG. 1) from a compliance check agent executed by a continuous build tool server in some embodiments.

After process 400 begins, the process can determine a type of infrastructure as a service (IaaS) being used to deploy the code stack at 404. This determination can be made in any suitable manner in some embodiments. For example, in some embodiments, this determination can be made based on the code template and/or metadata sent at 308 (FIG. 3).

Next, at 406, process 400 can retrieve the first policy for the IaaS service type determined at 404. This policy can be received in any suitable manner in some embodiments. For example, in some embodiments, the policy can be read from a database of policies. The policy can have any suitable content and/or requirements. For example, in some embodiments, the policy can indicate that there shouldn't be any IAM users who have not logged in for the last 30 days.

Below is a table with examples of different policies that can be checked for different IaaS services in accordance with some embodiments:

| Policy Name | IaaS Service |
|---|---|
| Unused IAM Users | AWS |
| Inactive IAM Users | AWS |
| MFA Enabled for Deleting CloudTrail Bucket | AWS |
| MFA Enabled for Root Account | AWS |
| MFA Enabled for IAM Users | AWS |
| IAM Users with Multi-Mode Access | AWS |
| Access Logging Enabled for CloudTrail S3 Bucket | AWS |
| CloudTrail Integration with CloudWatch Enabled | AWS |
| CloudTrail Multi-region Logging Enabled | AWS |
| ELB Access Logging Enabled | AWS |
| VPC Flow Logs Enabled | AWS |
| Unrestricted CIFS Access | AWS |
| Unrestricted MSSQL Access | AWS |
| Unrestricted FTP Access | AWS |
| Unrestricted ICMP Access | AWS |
| Unrestricted MongoDB Access | AWS |
| Unrestricted DNS Access | AWS |
| Unrestricted MySQL Access | AWS |
| Unrestricted NetBIOS Access | AWS |
| Unrestricted Oracle Database Access | AWS |
| Unrestricted PostgreSQL Access | AWS |
| Unrestricted Remote Desktop Access | AWS |
| Unrestricted RPC Access | AWS |
| Unrestricted SMTP Access | AWS |
| Unrestricted SSH Access | AWS |
| Unrestricted Telnet Access | AWS |
| Unrestricted Access to AMIs | AWS |
| Unrestricted Inbound Access on Uncommon Ports | AWS |
| Unrestricted Access to RDS Instances | AWS |
| Unnecessary Access Keys | AWS |
| Unused SSH Public Keys | AWS |
| IAM Policies Attached to Groups or Roles Only | AWS |
| Strong Password Policy | AWS |
| HTTPS CloudFront Distributions | AWS |
| CloudTrail Logs Encrypted at Rest | AWS |
| Unrestricted Access to CloudTrail Bucket | AWS |
| EBS Data Encryption | AWS |
| EC2 Security Group Inbound Access Configuration | AWS |
| EC2 Security Group Port Configuration | AWS |
| Provisioning Access to Resources Using IAM Roles | AWS |
| Access Key Check for Root Account | AWS |
| Database Encryption for RDS | AWS |
| Unrestricted Outbound Access | AWS |
| Unrestricted Access to S3 Bucket | AWS |
| Unencrypted S3 Buckets | AWS |
| IAM Access Key Rotation Setup | AWS |
| Hardware MFA Enabled for Root Account | AWS |
| Key rotation for customer created CMKs | AWS |
| AWS Resources Tags | AWS |
| Publicly Writable S3 Buckets | AWS |
| AWS Lambda | AWS |
| Auditing on SQL databases | AZURE |
| Transparent Data Encryption on SQL databases | AZURE |
| Email service and co-administrators is enabled for SQL databases | AZURE |
| Threat detection types for SQL databases | AZURE |
| Threat detection on SQL databases | AZURE |
| Secure Transfer for Storage Accounts | AZURE |
| Storage Service Encryption for Storage Accounts | AZURE |
| Enable VM agent on Virtual Machines | AZURE |
| Latest OS Patch Updates Enabled for Virtual Machines | AZURE |
| Check LogProfile exists for a subscription | AZURE |
| Security contact emails is set in Security Center | AZURE |
| Security Contact Phone number is set in Security Center | AZURE |
| Data collection enabled in Security Center | AZURE |
| Disk encryption enabled in Security Center | AZURE |
| Endpoint protection enabled in Security Center | AZURE |
| JIT Network Access enabled in Security Center | AZURE |
| Next generation firewall enabled in Security Center | AZURE |
| Network security groups enabled in Security Center | AZURE |
| OS vulnerabilities check enabled in Security Center | AZURE |
| Send email also to subscription owners enabled in Security Center | AZURE |
| Send me emails about alerts enabled in Security Center | AZURE |
| SQL auditing &amp; Threat detection enabled in Security Center | AZURE |
| SQL Encryption enabled in Security Center | AZURE |
| Storage Encryption enabled in Security Center | AZURE |
| System updates enabled in Security Center | AZURE |
| Vulnerability assessment enabled in Security Center | AZURE |
| Web application firewall enabled in Security Center | AZURE |
| Unrestricted RDP Access in network security groups | AZURE |
| Unrestricted SSH Access in network security groups | AZURE |
| Unrestricted Telnet Access in network security groups | AZURE |
| World Readable S3 Buckets | AWS |
| CloudTrail Logs Encrypted with CMKs | AWS |
| EC2 instance belongs to a VPC | AWS |
| Verify if Default Security Group is used by EC2 | AWS |
| Unrestricted Access to non-HTTP/HTTPS ports | AWS |
| CloudTrail Logging Disabled for Account | AWS |
| Validate CloudTrail Log File Integrity | AWS |
| MFA Delete Enabled on S3 Buckets | AWS |
| Check Lifecycle policy on S3 Bucket | AWS |
| Sufficient RDS backup retention period | AWS |
| Default VPCs are used | AWS |
| Unrestricted MSSQL Database Access (UDP) | AWS |
| Unused Security Groups | AWS |
| KMS Key scheduled for deletion | AWS |
| RDS Last Restorable Time Check | AWS |
| RDS Database not encrypted with Customer Managed KMS Key | AWS |
| Unrestricted VNC Listener Access | AWS |
| Unrestricted VNC Server Access | AWS |
| Max Subnets per VPC | AWS |
| VPC Security Group Limit | AWS |
| VPC Account Limit | AWS |
| Nearing limits of EC2 instances | AWS |
| RDS Snapshot with Public Permissions | AWS |
| RDS Cluster Snapshot with Public Permissions | AWS |
| Redshift Cluster Publicly Accessible | AWS |
| Unencrypted Redshift Cluster | AWS |
| Redshift Cluster Not Encrypted with Customer Managed KMS Key | AWS |
| VPC Private Gateway Limit | AWS |
| Customer Gateway Limit | AWS |
| Access Logging Enabled for S3 Bucket | AWS |
| Customer Managed Keys Not in Use | AWS |
| Unencrypted AMI | AWS |
| Insecure Ciphers in CloudFront Distribution | AWS |
| EBS volumes detected and unattached | AWS |
| Untagged Resources | AWS |
| AWS CloudFront CDN not in use | AWS |
| EBS volume does not have recent snapshot | AWS |
| NAT gateway not used | AWS |
| IAM Support Role Check | AWS |
| Default access keys in use | AWS |
| AWS DNS service must not be used | AWS |
| AWS Config is not enabled | AWS |
| RDS event subscription not enabled | AWS |
| S3 object versioning enabled | AWS |
| SQS cross account access | AWS |
| Custom IAM Policy Grants Too Many Privileges | AWS |
| Single IAM Administrator Detected | AWS |
| SNS cross account access | AWS |
| Nearing regional limit for elastic IP addresses | AWS |
| McAfee Endpoint Security Threat Prevention | AWS |
| McAfee Endpoint Security Adaptive Threat Protection | AWS |
| McAfee Agent installed on server endpoints | AWS |
| McAfee Application Control | AWS |
| McAfee VirusScan Enterprise for Linux | AWS |
| McAfee VirusScan Enterprise | AWS |
| McAfee Network Intrusion Prevention | AWS |
| World Readable Azure Blob Storage Containers | AZURE |
| Unrestricted CIFS Access in network security groups | AZURE |
| Unrestricted DNS Access in network security groups | AZURE |
| Unrestricted FTP Access in network security groups | AZURE |
| Unrestricted MongoDB Access in network security groups | AZURE |
| Unrestricted MSSQL Access in network security groups | AZURE |
| Unrestricted MSSQL Database Access (UDP) in network security groups | AZURE |
| Unrestricted MySQL Access in network security groups | AZURE |
| Unrestricted NetBIOS Access (UDP) in network security groups | AZURE |
| Unrestricted NetBIOS Access in network security groups | AZURE |
| Unrestricted Oracle Database Access in network security groups | AZURE |
| Unrestricted PostgreSQL Access in network security groups | AZURE |
| Unrestricted RPC Access in network security groups | AZURE |
| Unrestricted SMTP Access in network security groups | AZURE |
| Unrestricted Access to non-HTTP/HTTPS ports in network security groups | AZURE |
| Unrestricted VNC Listener Access in network security groups | AZURE |
| Unrestricted VNC Server Access in network security groups | AZURE |
| Diagnostic logs not enabled in Event Hub | AZURE |
| Vulnerability assessment not installed | AZURE |
| Security configurations rules not applied | AZURE |
| More than one owner not designated on subscription | AZURE |
| 3 or more owners designated on subscription | AZURE |
| External accounts with owner permissions from subscription not removed | AZURE |
| External accounts with read permissions from subscription not removed | AZURE |
| External accounts with write permissions from subscription not removed | AZURE |
| Azure Resources Tags | AZURE |
| Azure Untagged Resources | AZURE |
| Endpoint Protection health issues not resolved | AZURE |
| Unrestricted network access enabled in storage account | AZURE |
| Azure AD authentication not enabled in SQL server | AZURE |
| Monitoring agent not installed on VM | AZURE |
| Monitoring agent health issues not resolved | AZURE |
| Auditing not enable on SQL servers | AZURE |
| Disk encryption not applied | AZURE |
| MFA for accounts with owner permissions on subscription not enabled | AZURE |
| MFA for accounts with read permissions on subscription not enabled | AZURE |
| MFA for accounts with write permissions on subscription not enabled | AZURE |
| IP restrictions for Web Application not configured | AZURE |
| Check if CORS allows every resource to access your Web Application | AZURE |
| Custom domains for your Web Application not used | AZURE |
| Latest supported Java version for Web Application not used | AZURE |
| Latest supported .NET Framework for Web Application not used | AZURE |
| Latest supported PHP version for Web Application not used | AZURE |
| Latest supported Python version for Web Application not used | AZURE |
| Remote debugging not turned off for Web Application | AZURE |
| Web Application not limited over HTTPS | AZURE |
| Web Sockets not disabled for Web Application | AZURE |
| Function App access not limited over HTTPS | AZURE |
| IP restrictions for Function App not configured | AZURE |
| Check if CORS allows every resource to access your Function Application | AZURE |
| Custom domains for Function App not used | AZURE |
| Remote debugging not turned off for Function App | AZURE |
| Web Sockets not disabled for function Application | AZURE |
| Deprecated accounts from subscription not removed | AZURE |
| Deprecated accounts with owner permissions from subscription not removed | AZURE |
| Adaptive applications controls not enabled | AZURE |
| All resources are allowed to access your application | AZURE |
| Latest supported Node.js version for Web Application not used | AZURE |
| Application protection not finalized | AZURE |
| Check if VM is rebooted after system updates | AZURE |
| Traffic is not routed through NGFW only | AZURE |
| OS version is not updated | AZURE |
| Monitor Azure Active Directory Authentication in Service Fabric enabled in Security Center | AZURE |
| Monitor the provisioning of an Azure AD administrator for SQL server enabled in Security Center | AZURE |
| Monitor access rules in Event Hub namespaces enabled in Security Center | AZURE |
| Monitor access rules in Event Hubs enabled in Security Center | AZURE |
| Adaptive Application Controls enabled in Security Center | AZURE |
| Monitor Configure IP restrictions for API App enabled in Security Center | AZURE |
| Monitor disable remote debugging for API App enabled in Security Center | AZURE |
| Monitor disable web sockets for API App enabled in Security Center | AZURE |
| Monitor the use of HTTPS in API App enabled in Security Center | AZURE |
| Monitor the CORS restrictions for API App enabled in Security Center | AZURE |
| Monitor the custom domain use in API App enabled in Security Center | AZURE |
| Monitor use latest DotNet in API App enabled in Security Center | AZURE |
| Monitor use latest Java in API App enabled in Security Center | AZURE |
| Monitor use latest PHP in API App enabled in Security Center | AZURE |
| Monitor use latest Python in API App enabled in Security Center | AZURE |
| Monitor classic compute VMs enabled in Security Center | AZURE |
| Monitor classic storage accounts enabled in Security Center | AZURE |
| Monitor cluster protection level in Service Fabric enabled in Security Center | AZURE |
| Monitor diagnostic logs in Azure App Services enabled in Security Center | AZURE |
| Monitor diagnostic logs in Batch accounts enabled in Security Center | AZURE |
| Monitor diagnostic logs in Data Lake Analytics accounts enabled in Security Center | AZURE |
| Monitor diagnostic logs in Data Lake Store accounts enabled in Security Center | AZURE |
| Monitor diagnostic logs in Event Hub accounts enabled in Security Center | AZURE |
| Monitor diagnostic logs in Key Vault vaults enabled in Security Center | AZURE |
| Monitor diagnostic logs in Logic Apps workflows enabled in Security Center | AZURE |
| Monitor diagnostic logs in Azure Redis Cache enabled in Security Center | AZURE |
| Monitor diagnostic logs in Azure Search service enabled in Security Center | AZURE |
| Monitor diagnostic logs in Service Bus enabled in Security Center | AZURE |
| Monitor diagnostic logs in Service Fabric enabled in Security Center | AZURE |
| Monitor diagnostic logs in Stream Analytics enabled in Security Center | AZURE |
| Monitor disabling of unrestricted network access to storage account enabled in Security Center | AZURE |
| Monitor encryption of automation accounts enabled in Security Center | AZURE |
| Monitor Configure IP restrictions for Function App enabled in Security Center | AZURE |
| Monitor disable remote debugging for Function App enabled in Security Center | AZURE |
| Monitor disable web sockets for Function App enabled in Security Center | AZURE |
| Monitor the use of HTTPS in function App enabled in Security Center | AZURE |
| Monitor the CORS restrictions for API Function enabled in Security Center | AZURE |
| Monitor the custom domain use in Function App enabled in Security Center | AZURE |
| Monitor minimus number of owners enabled in Security Center | AZURE |
| Monitor maximum number of owners enabled in Security Center | AZURE |
| Monitor MFA for accounts with owner permissions enabled in Security Center | AZURE |
| Monitor MFA for accounts with read permissions enabled in Security Center | AZURE |
| Monitor MFA for accounts with write permissions enabled in Security Center | AZURE |
| Monitor remove deprecated accounts with owner permissions enabled in Security Center | AZURE |
| Monitor remove deprecated accounts enabled in Security Center | AZURE |
| Monitor remove external accounts with owner permissions enabled in Security Center | AZURE |
| Monitor remove external accounts with read permissions enabled in Security Center | AZURE |
| Monitor remove external accounts with write permissions enabled in Security Center | AZURE |
| Monitor metric alerts in Batch accounts enabled in Security Center | AZURE |
| Monitor Service Bus namespace authorization rules enabled in Security Center | AZURE |
| Monitor the secure transfer to storage account enabled in Security Center | AZURE |
| Monitor SQL Db encryption enabled in Security Center | AZURE |
| Monitor SQL vulnerability assessment results enabled in Security Center | AZURE |
| Monitor SQL Servers auditing enabled in Security Center | AZURE |
| System Configurations enabled in Security Center | AZURE |
| Monitor of using built-in RBAC rules enabled in Security Center | AZURE |
| Monitor use of DDoS protection for virtual network enabled in Security Center | AZURE |
| Monitor Configure IP restrictions for Web App enabled in Security Center | AZURE |
| Monitor disable remote debugging for Web App enabled in Security Center | AZURE |
| Monitor disable web sockets for Web App enabled in Security Center | AZURE |
| Monitor the use of HTTPS in Web App enabled in Security Center | AZURE |
| Monitor the CORS restrictions for API Web enabled in Security Center | AZURE |
| Monitor the custom domain use in Web App enabled in Security Center | AZURE |
| Monitor use latest DotNet in Web App enabled in Security Center | AZURE |
| Monitor use latest Java in Web App enabled in Security Center | AZURE |
| Monitor use latest Node js in Web App enabled in Security Center | AZURE |
| Monitor use latest PHP in Web App enabled in Security Center | AZURE |
| Monitor use latest Python in Web App enabled in Security Center | AZURE |

Then, at 408, process 400 can evaluate the code template in view of the policy. This evaluation can be performed in any suitable manner. For example, in some embodiments, this evaluation can determine if the code template will cause the code stack to create any security incident with respect to configuration.

At 410, process 400 can determine whether there are any more policies for the type of IaaS service determined at 404. The determination can be made in any suitable manner in some embodiments. For example, in some embodiments, process 400 can query a database to determine if there are any more policies for the type of IaaS service.

If it is determined at 410 that there is one or more policy remaining, then process 400 can retrieve the next policy for the IaaS service type at 412 and then loop back to 408. This policy can be received in any suitable manner in some embodiments. For example, in some embodiments, the policy can be read from a database of policies. The policy can have any suitable content and/or requirements. For example, in some embodiments, the policy can indicate that there shouldn't be any IAM users who have not logged in for the last 30 days.

Otherwise, if it is determined at 410 that there are no policies remaining, then process 400 can determine whether the code template passed at 414, return compliance check results at 416, and end at 418. The determination of whether the code template passed can be made in any suitable manner. For example, in some embodiments, the code template can be determined to have passed when a suitable percentage (e.g., 80%, 90%, 100%, or any other suitable percentage) of the requirements of the one or more policies have been met. The compliance check results can include any suitable information and can be returned in any suitable manner. For example, in some embodiments, the compliance check results can indicate that the compliance check passed. As another example, the compliance check results can indicate details of a security violation in a code template such as the owner of the template, the date and the time when the template was put into the source of the trigger, the type of policy violations that were found, and what fix is needed for the security violation. As yet another example, the compliance check results can be sent as a message to the compliance check agent.

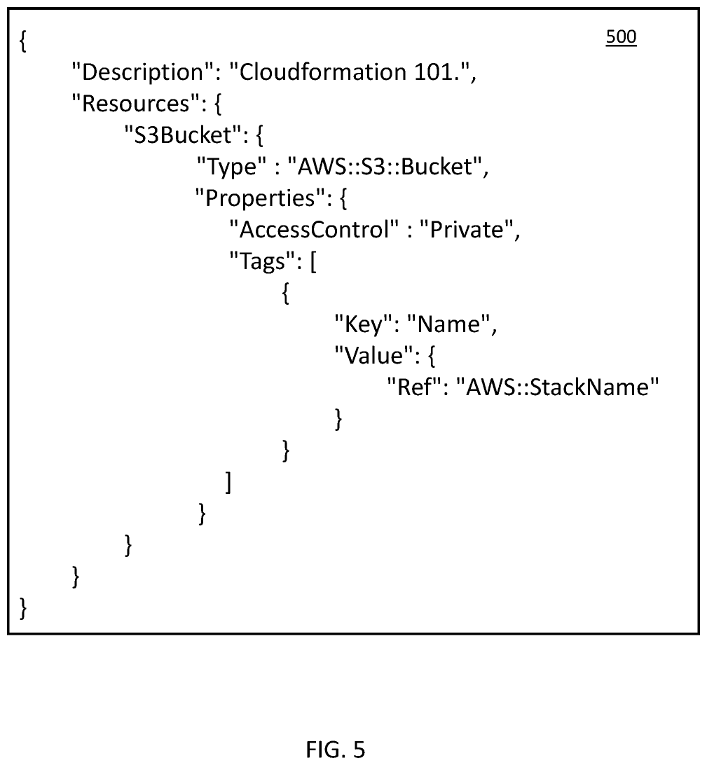

An example 500 of a code template in accordance with some embodiments is shown in FIG. 5. As illustrated, the template indicates a description “Cloudformation 101” and indicates that an AMAZON WEB SERVICE (AWS) S3 bucket is to be used. The code template can be for Amazon Web Services, Microsoft Azure, Google Cloud Platform or Terraform template which can be used for any of the three service providers. Any suitable additional or alternative information can be provided in a code template in some embodiments.

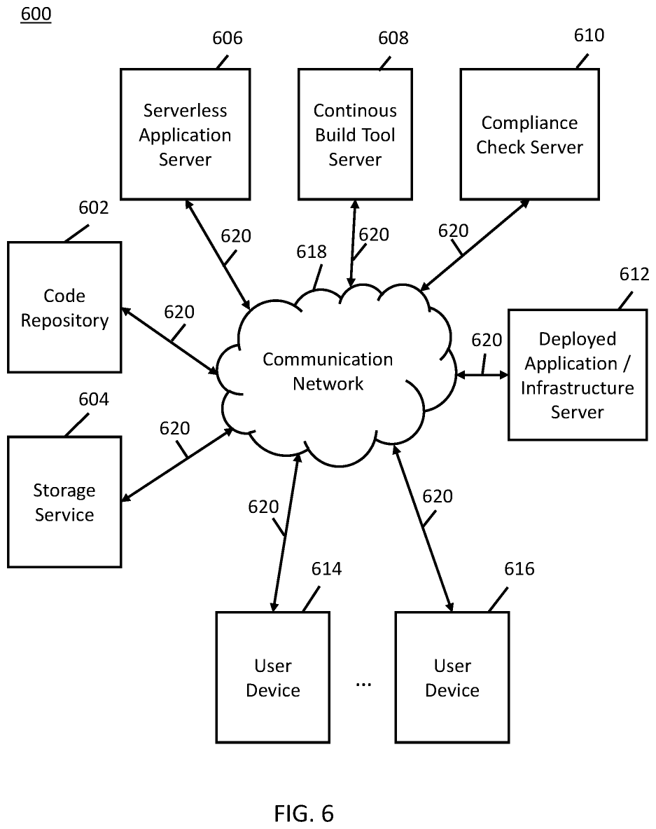

FIG. 6 illustrates an example 600 of hardware components that can be used in some embodiments. As shown, hardware 600 includes a code repository 602, a storage service 604, a serverless application server 606, a continuous build tool server 608, a compliance check server 610, a deployed application/infrastructure server 612, user devices 614 and 616, and a communication network 618.

Code repository 602 can be any suitable hardware for storing code in accordance with some embodiments. For example, code repository 602 can be a hardware server. More particularly, in some embodiments, code repository 602 can be a hardware server that implements AMAZON WEB SERVICE (AWS) CODECOMMIT, APACHE SUBVERSION, GIT, and/or any other suitable software for managing versions of code.

Storage service 604 can be any suitable hardware for storing code in accordance with some embodiments. For example, storage service 604 can be a hardware server. More particularly, in some embodiments, storage service 604 can be a hardware server that implements AWS S3, MICROSOFT AZURE BLOBS, and/or any other suitable software for storing code.

Serverless application server 606 can be any suitable hardware for hosting a serverless application and/or process 200 of FIG. 2 in accordance with some embodiments. For example, serverless application server 606 can be a hardware server. More particularly, in some embodiments, serverless application server 606 can be a hardware server that implements AWS LAMBDA, AZURE FUNCTIONS, and/or any other suitable software for providing a serverless computing platform.

Continuous build tool server 608 can be any suitable hardware for executing a continuous build process and/or process 300 of FIG. 3 in accordance with some embodiments. For example, continuous build tool server 608 can be a hardware server. More particularly, in some embodiments, continuous build tool server 608 can be a hardware server that implements AWS CODEBUILD and/or any other suitable software for building a code stack based on a code template.

Compliance check server 610 can be any suitable hardware for performing a compliance check process and/or process 400 of FIG. 4 in accordance with some embodiments. For example, compliance check server 610 can be a hardware server.

Deployed application/infrastructure server 612 can be any suitable hardware for hosting a deployed application and/or infrastructure in accordance with some embodiments. For example, deployed application/infrastructure server 612 can be a hardware server.

User devices 614 and 616 can be any suitable hardware for enabling a user to create, update, and/or delete code and/or a code template in accordance with some embodiments. For example, user devices 614 and 616 can be any suitable computer, such as a desk top computer, a laptop computer, a tablet computer, a smart phone, and/or any other suitable computer device.

Communication network 618 can be any suitable combination of one or more wired and/or wireless networks in some embodiments. For example, communication network 618 can include any one or more of the Internet, a mobile data network, a satellite network, a local area network, a wide area network, a telephone network, a cable television network, a WiFi network, a WiMax network, and/or any other suitable communication network.

Code repository 602, storage service 604, serverless application server 606, continuous build tool server 608, compliance check server 610, deployed application/infrastructure server 612, and user devices 614 and 616 can be connected by one or more communications links 620 to communication network 618. The communications links can be any communications links suitable for communicating data among code repository 602, storage service 604, serverless application server 606, continuous build tool server 608, compliance check server 610, deployed application/infrastructure server 612, user devices 614 and 616, and communication network 618, such as network links, dial-up links, wireless links, hard-wired links, any other suitable communications links, or any suitable combination of such links.

Although one code repository 602, one storage service 604, one serverless application server 606, one continuous build tool server 608, one compliance check server 610, one deployed application/infrastructure server 612, two user devices 614 and 616, and one communication network 618 are shown in FIG. 1 to avoid over-complicating the figure, any suitable numbers (including zero in some embodiments) of these devices can be used in some embodiments.

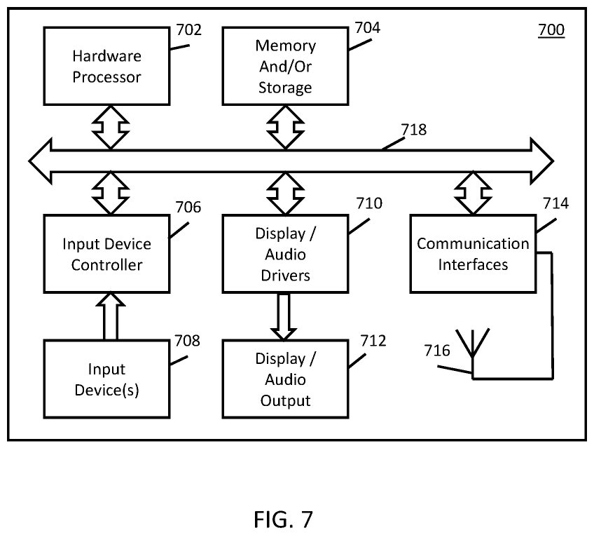

Code repository 602, storage service 604, serverless application server 606, continuous build tool server 608, compliance check server 610, deployed application/infrastructure server 612, and user devices 614 and 616 can be implemented using any suitable hardware in some embodiments. For example, in some embodiments, code repository 602, storage service 604, serverless application server 606, continuous build tool server 608, compliance check server 610, deployed application/infrastructure server 612, and/or user devices 614 and 616 can be implemented using any suitable general-purpose computer or special-purpose computer. For example, a user device, such as a tablet computer, can be implemented using a special-purpose computer. Any such general-purpose computer or special-purpose computer can include any suitable hardware. For example, as illustrated in example hardware 700 of FIG. 7, such hardware can include hardware processor 702, memory and/or storage 704, an input device controller 706, an input device 708, display/audio drivers 710, display and audio output circuitry 712, communication interface(s) 714, an antenna 716, and a bus 718.

Hardware processor 702 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 704 can be any suitable memory and/or storage for storing programs, data, and/or any other suitable information in some embodiments. For example, memory and/or storage 704 can include random access memory, read-only memory, flash memory, hard disk storage, optical media, and/or any other suitable memory.

Input device controller 706 can be any suitable circuitry for controlling and receiving input from an input device 708 in some embodiments. For example, input device controller 706 can be circuitry for receiving input from a touch screen, from one or more buttons, from a voice recognition circuit, from a microphone, from a camera, from an optical sensor, from an accelerometer, from a temperature sensor, from a near field sensor, and/or any other type of input device.

Display/audio drivers 710 can be any suitable circuitry for controlling and driving output to one or more display/audio output circuitries 712 in some embodiments. For example, display/audio drivers 710 can be circuitry for driving an LCD display, a speaker, an LED, or any other type of output device.

Communication interface(s) 714 can be any suitable circuitry for interfacing with one or more communication networks, such as network 618 as shown in FIG. 1. For example, interface(s) 714 can include network interface card circuitry, wireless communication circuitry, and/or any other suitable type of communication network circuitry.

Antenna 716 can be any suitable one or more antennas for wirelessly communicating with a communication network in some embodiments. In some embodiments, antenna 716 can be omitted when not needed.

Bus 718 can be any suitable mechanism for communicating between two or more components 702, 704, 706, 710, and 714 in some embodiments.

Any other suitable components can be included in hardware 700 in accordance with some embodiments.

It should be understood that at least some of the above described blocks of the process of FIGS. 1-4 can be executed or performed in any order or sequence not limited to the order and sequence shown in and described in the figures. Also, some of the above blocks of the process of FIGS. 1-4 can be executed or performed substantially simultaneously where appropriate or in parallel to reduce latency and processing times. Additionally or alternatively, some of the above described blocks of the process of FIG. 1-4 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, systems, methods, and media for determining security compliance of continuous build software are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for determining security compliance of continuous build software, comprising:
a memory; and
a hardware processor coupled to the memory and configured to:
receive a trigger from a continuous build tool indicating that code has been created or updated;
receive a code template corresponding to the code;
check the code template against a plurality of policies to determine if there is a security violation; and
indicate that the code template has passed a compliance check prior to a code stack for the template being built by the continuous build tool.

2. The system of claim 1, wherein the trigger is based on a trigger sent to the continuous build tool by a serverless application.

3. The system of claim 1, wherein the hardware processor is also configured to receive metadata with the trigger.

4. The system of claim 3, wherein the metadata indicates that code was checked-in to a code repository.

5. The system of claim 3, where the metadata indicates that code was uploaded to a storage service.

6. The system of claim 3, wherein the metadata indicates that the code was created or updated.

7. The system of claim 1, wherein the hardware processor is also configured to scan the code stack for security violations after the code stack is built.

8. A method for determining security compliance of continuous build software, comprising:
receiving a trigger at a hardware processor from a continuous build tool indicating that code has been created or updated;
receiving a code template corresponding to the code at the hardware processor;
checking the code template against a plurality of policies to determine if there is a security violation; and
indicating that the code template has passed a compliance check prior to a code stack for the template being built by the continuous build tool.

9. The method of claim 8, wherein the trigger is based on a trigger sent to the continuous build tool by a serverless application.

10. The method of claim 8, further comprising receiving metadata with the trigger.

11. The method of claim 10, wherein the metadata indicates that code was checked-in to a code repository.

12. The method of claim 10, where the metadata indicates that code was uploaded to a storage service.

13. The method of claim 10, wherein the metadata indicates that the code was created or updated.

14. The method of claim 8, further comprising scanning the code stack for security violations after the code stack is built.

15. A non-transitory computer-readable medium containing computer-executable instructions that, when executed by a processor, cause the processor to perform a method for determining security compliance of continuous build software, the method comprising:
receiving a trigger at a hardware processor from a continuous build tool indicating that code has been created or updated;
receiving a code template corresponding to the code at the hardware processor;
checking the code template against a plurality of policies to determine if there is a security violation; and
indicating that the code template has passed a compliance check prior to a code stack for the template being built by the continuous build tool.

16. The non-transitory computer-readable medium of claim 15, wherein the trigger is based on a trigger sent to the continuous build tool by a serverless application.

17. The non-transitory computer-readable medium of claim 15, where the method further comprises receiving metadata with the trigger.

18. The non-transitory computer-readable medium of claim 17, wherein the metadata indicates that code was checked-in to a code repository.

19. The non-transitory computer-readable medium of claim 17, where the metadata indicates that code was uploaded to a storage service.

20. The non-transitory computer-readable medium of claim 15, wherein the method further comprises scanning the code stack for security violations after the code stack is built.
